(19) United States
(12) Patent Application Publication
(10) Pub. No.: US 2012/0259753 A1
(43) Pub. Date: Oct. 11, 2012

(54) SYSTEM AND METHOD FOR MANAGING COLLABORATIVE FINANCIAL FRAUD DETECTION LOGIC

(76) Inventors: Amir Orad, Scarsdale, NY (US); Uri Eliahu Maimon, Tel-Aviv (IL); Shlomi Cohen-Ganor, Beit Zayit (IL)

(21) Appl. No.: 13/081,822

(22) Filed: Apr. 7, 2011

(51) Int. Cl. G06Q 40/00

(52) U.S. Cl. 705/35

(57) ABSTRACT

A system and method for sharing detection logic is disclosed. Detection logic may be uploaded to a network. Detection logic may shared by for example enabling devices to download detection logic from the network. Detection logic may be provided to a detection system that may operate based on the provided logic to detect risks. A detected risk may be related to financial transactions. Other embodiments are described and claimed.

### FIELD OF THE INVENTION

The present invention relates to the field of risk management. In particular, the present invention is related to risks associated with financial transactions.

### BACKGROUND OF THE INVENTION

Advancements in computing and communication technologies have enabled significant changes in the way financial institutions, businesses, organizations, government agencies and the like operate and function. In many such organizations, institutions or agencies, electronic business documents or transactions may be the formal and/or official form of transacting business. A large number and variety of documents and transactions are regularly exchanged between, for example, agencies and business partners, financial institutions and the private sector regardless of distance and geographic location.

Financial and other institutions may need to process large amounts of monetary or other transactions on a daily basis. Many of these transactions involve a transfer of confidential, sensitive and/or private information or data as well as include business transactions such as purchase orders or money transfers. For example, many such transactions involve a transfer of money, e.g., between bank accounts. However, some of these transactions may be a result of fraudulent activity. For example, a “fraudster” may use a transaction to transfer money from its rightful owner's bank account to an account maintained or owned by the fraudster. If not detected and/or blocked, fraudulent transactions or transfers may cause a variety of undesirable effects such as loss of money, loss of customers and/or increased costs.

Identifying and/or detecting fraudulent transactions may be a complicated task, and given the high volumes, time constraints and complexity, may involve automated and/or semi-automated fraud identification and/or detection systems coupled with some level of human surveillance. For example, analytical or other models implemented in software, incorporating complex logic, may be used to identify, detect and/or prevent fraud. Other systems and/or methods of detection and/or prevention of fraudulent transactions may be statistical analysis of historical data, possibly coupled with predictive modeling capabilities or ad-hoc querying of historical data coupled with manual surveillance, for example, using a case management tool as known in the art. Such methods, systems and tools may allow a business analyst or other, possibly novice users to query historic data, attempting to identify historical fraud events. Yet another challenge financial institutions face is regulations. For example, governments may institute regulations that may need to be adhered to when digitally transacting money, enforcing regulations may require knowledge as well as implementation, e.g., by systems that implement logic according to regulations.

Detecting threats or risks related to financial fraud techniques may often take time. A threat may be, at first, limited to a specific geographic region or a specific business before expanding. Accordingly, various methods and systems designed for combating threats include systems and/or methods for sharing data so that information related to a threat may be shared between potential victims. For example, data sharing consortiums and networks have long been used in financial risk management, particularly in credit risk and financial crime prevention.

However, prevention of threats through sharing of data has a number of drawbacks. For example, data alone, when taken out of context, may have limited value, and may, in some cases, result in poor decisions (e.g., false positives). Further, ensuring data quality from unsupervised sources or contributors may be a complicated task. Furthermore, data or information related to a threat may not always be readily used in preventing the threat, for example, data related to a fraud may need to be analyzed and, based on the analysis, a system may be configured or developed in order to implement measures for combating the fraud or handling a related risk.

### SUMMARY OF EMBODIMENTS OF THE INVENTION

Embodiments of the invention may enable subscribers to share logic or rules usable in detecting risks related to digital or financial transactions. In particular, logic usable in detecting risks related to financial digital transactions may be shared by a community of subscribers or users. A risk detection logic may be uploaded to a network. A server may store a plurality of risk detection logic modules, components or elements. Risk detection logic may be included in a network-enabled logic unit (NLU) or other data structure that may include, in addition to the risk detection logic, any parameter or information related to the risk detection logic. Information related to a risk detection logic may be uploaded to a network by subscribers. For example, rating of a risk detection logic or other feedback or comments may be uploaded to the network. Risk detection logic may be downloaded by subscribers and provided to a detection system or engine that may detect risks based on downloaded risk detection logic. Subscribers may search for risk detection logic by providing various criteria or search parameters.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1A shows an exemplary system according to embodiments of the invention;

FIG. 1B shows an exemplary computing device according to embodiments of the invention;

FIG. 2 shows an exemplary screen display according to embodiments of the invention;

FIG. 3A shows an exemplary screen display according to embodiments of the invention;

FIG. 3B shows an exemplary screen display according to embodiments of the invention;

FIG. 4 shows an exemplary screen display according to embodiments of the invention; and

FIG. 5 is a flowchart describing a method of sharing risk detection logic according to embodiments of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention, e.g., in a device, system and/or method may be used to manage risks or detect or prevent threats. Embodiments of the invention may enable creation and distribution of risk detection and/or prevention. Although threats or risks related to transactions, and more particularly, financial transactions, are described herein, it will be understood that embodiments or the invention are not limited to these aspects. Any threats related to computing devices or systems or transactions may be detected by embodiments of the invention. Logic related to detection and/or prevention of any threat or risk, e.g., viruses, worms or any malware or hostile software may be shared, e.g., by a community of subscribers in a network. Accordingly, embodiments of the invention may be used to create and share logic or rules that may be executed to detect financial frauds, enforce policies and/or regulations and detect and prevent threats related to monetary digital transactions. Shared risk management logic may be executed by detection and/or prevention systems that may be executed on users' computing devices. As discussed, logic to detect and/or prevent other threats, e.g., viruses, worms or other hostile or harmful software may likewise be shared and executed by embodiments of the invention, however, risks and/or threats related to financial frauds will mainly be discussed herein.

Unlike prior art systems and methods directed to sharing of data related to risks, embodiments of the invention may enable sharing logic usable in combating threats, possibly in addition to sharing relevant information. According to embodiments of the invention, users may contribute logic or rules to a network where the contribution may be shared by members of the network, e.g., in a fashion similar to the way content is shared over social networks (accordingly, the term risk management social network may be used herein). In some embodiments, users may rate contributions (e.g., logic or rules) thus improving the quality of content in the network. Users may be enabled to search for contributions based on various search criteria.

In some embodiments, e.g., based on a configuration parameter, risk management logic may be updated automatically based on various criteria, e.g., based on a rating, an efficiency, score factors, various statistics or other parameters related to a risk management logic. In other embodiments, users may manually update local risk management logic. Risk management logic or rules may be executed by a detection and/or prevention system that may be executed on users' computing devices. Logic created and shared may be relevant or related to financial risk management, detecting and/or preventing money laundering, financial or other frauds or any effects caused by malware, hostile or fraudulent activities as well as to monitoring or enforcing, corporate security, brokerage compliance, policies and/or regulations. Accordingly, advantages such as combined experience of subscribers to a network, as well as in the ability to receive timely updates may be enabled by embodiments of the invention. A subscriber may be a user (via for example a terminal or subscriber device) of services or functionality provided by embodiments of the invention.

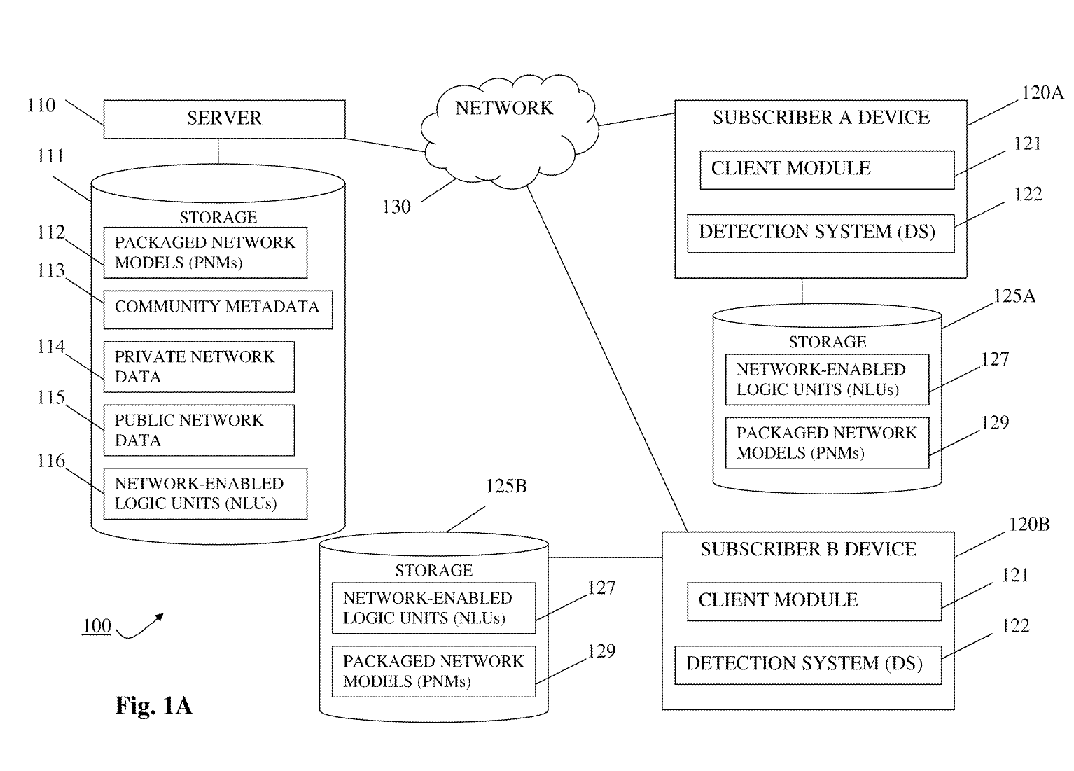

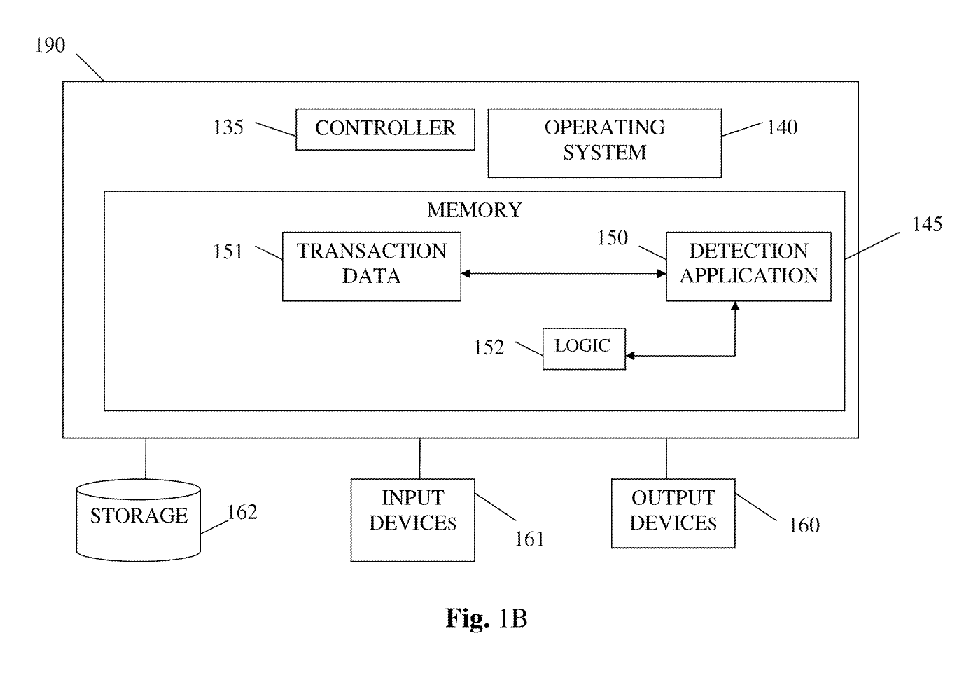

Reference is made to FIG. 1A, an exemplary system 100 according to embodiments of the invention. As shown, system 100 may include a server 110 operatively connected to storage 111, a subscriber device A 120A operatively connected to a storage 125A and a subscriber B device 120B operatively connected to a storage 125B. As shown, the system may include a network 130 (e.g., the Internet) connecting components such as server 110, subscriber device A 120A and subscriber device B 120B. As further shown, devices 120A and 120B may include or be associated with a client module 121 and a detection system (DS) 122. As shown, storage units 125A and 125B may store one or more network-enabled logic units (NLUs) 127 and packaged network models (PNMs) 129. Other data may be stored on storages 125A and 125B. For example, usage and incident data described herein may be stored on these storage units and uploaded to server 110 from these storage units. Community metadata 113, private network data 114 and public network data 115 stored on storage 111 connected to server 110 may include data uploaded from storage units 125A and/or 125B.

While in some embodiments, an NLU is used, in other embodiments, other formats for storing items such as logic or rules may be used. It will be noted that in some embodiments, NLUs 127 stored on storage unit 125A may be identical or similar to NLUs 127 stored on storage unit 125B and in other embodiments, cases or times, NLUs 127 stored on storage unit 125A may be different from, or even unrelated to, NLUs 127 stored on storage unit 125B. Likewise, in some cases, embodiments or time periods, PNMs 129 stored on storage unit 125A may be identical or similar to PNMs 129 stored on storage unit 125B and in other cases, embodiments or time periods, PNMs 129 stored on storage unit 125A may be different from, or even unrelated to, PNMs 129 stored on storage unit 125B.

Typically, client module 121 on device 120A may be similar to client module 121 on device 120B, however, in some cases, these modules may be different. For example, these modules may be differently compiled, linked or otherwise generated to execute on, or interact with, different operating systems that may reside on devices 120A and 120B. In some cases or embodiments, client module 121 on device 120A may be a software module or application that allows users and/or external systems (e.g. scheduler) to perform functions related to the network. Client module 121 may include a graphical user interface (GUI) component that may be implemented in various ways, e.g., a tab in a web page or an HTML page. The GUI component may be part of an existing front-end product, or a standalone front-end product, or a webpage served by the host. In the same system, client module 121 on device 120B may be a hardware or firmware module, e.g., an add-on card, a chip or an application specific integrated circuit (ASIC) installed on a computing device. Similarly, detection system or engine 122 on device 120A may be similar to detection system 122 on device 120B, however, these systems may be different. For example, these systems may be differently compiled, linked of otherwise generated to execute on, or interact with, different operating systems that may reside on devices 120A and 120B. In some cases or embodiments, detection system 122 on device 120A may be a software module and detection system 122 on device 120B may be a hardware or firmware module, e.g., an add-on card, a chip or an ASIC.

According to embodiments of the present invention, server 110 may be any suitable server computing device. For example, server 110 may be a personal, desktop or mobile computer. Typically, server 110 may be a powerful computer or set of computers capable of interacting with a large number of computing devices such as devices 120A and 120B, e.g., over network 130 and, possibly at the same time, perform various operations, e.g., store or retrieve data on/from storage 111, generate or analyze objects, e.g., objects stored on storage 111 and perform other operations, e.g., as described herein.

According to embodiments of the present invention, devices 120A and 120B may include or may be, for example, a personal computer, a desktop computer, a mobile computer, a laptop computer, a notebook computer, a terminal, a workstation or a server computer. In some embodiments, devices 120A and 120B may include or may be a Personal Digital Assistant (PDA) device, a mobile phone, a household appliance or any other suitable computing device. According to embodiments of the present invention, server 110 and devices 120A and 120B may include components such as, but not limited to, a plurality of central processing units (CPU) or any other suitable multi-purpose or specific processors or controllers, a plurality of input units, a plurality of output units, a plurality of memory units, and a plurality of storage units. Server 110 and devices 120A and 120B may additionally include other suitable hardware components and/or software components. Although for the sake of clarity, only two devices (120A and 120B) are shown, embodiments of the invention may include a large number of such or similar devices. In fact, in some embodiments, a very large number (e.g., tens of thousands) of devices similar to devices 120A and 120B may be included thus forming a community or social network like configuration. Likewise, although a single server 110 is shown, any number of serves may be included in a system according to embodiments of the invention, e.g., servers may be added as a network grows by adding user or subscriber devices. Generally, a subscriber may be an individual user or it may be an organization that is authorized to participate in a network, e.g., network 130. For example, a subscriber may be authenticated, registered or known by server 110 and may be allowed to upload and/or download data to/from the network e.g., to/from server 110. A host may be an organization that manages the network. For example, a host may be enabled to configure various aspects related to an operation of server 110 and/or network 130, e.g., a host may determine who may use server 110 and/or network 130, when such usage is enabled or permitted and/or other conditions related to using a system as shown by FIG. 1A.

Storage units 125A, 125B and 111 may be any component capable of storing digital information. In some cases, storage 111 may be or may include a relational database system, possibly including a relational database management system (RDBMS). For example, storage 111 and server 110 may be used in order to enable a large number of subscribers to share logic, accordingly, a suitable database and management system may be employed. Storage units 125A, 125B and 111 may include or may be, for example, a hard disk drive, a floppy disk drive, a Compact Disk (CD) drive, a CD-Recordable (CD-R) drive, or other suitable removable and/or fixed storage unit. Storage units 125A, 125B and 111 may include or may be a USB storage device, network storage device or a FLASH storage device. It will be recognized that the scope of the present invention is not limited or otherwise affected by the type, nature, operational and/or design aspects of storage units 125A, 125B and 111. For example, storage units 125A, 125B and 111 may include any suitable number of possibly different storage devices without departing from the scope of the present invention.

Network 130 may be, may include or may be part of a private or public IP network, or the Internet, or a combination thereof. Additionally or alternatively, network 130 may be, include or be part of a global system for mobile communications (GSM) network. For example, network 130 may include an IP network such as the Internet, a GSM related network and any equipment for bridging or otherwise connecting such networks as known in the art. In addition, network 130 may be, may include or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, a satellite communication network, a cellular communication network, any combination of the preceding and/or any other suitable communication systems and/or methods. Accordingly, numerous elements of network 130 are implied but not shown, e.g., access points, base stations, communication satellites, GPS satellites, routers, telephone switches, etc. It will be recognized that embodiments of the invention are not limited by the nature of network 130.

Network 130 may be a subscriber network. In some embodiments, only users and/or devices subscribed to network 130 may communicate and/or receive information over network 130. For example, a user or device may be required to be authenticated and/or subscribed, e.g., with or by server 110, in order to be enabled to communicate and/or receive information over network 130. In some embodiments, network 130 may be secured. For example, various devices installed on network 130 and/or methods employed may enable secured communication over network 130 such that private or confidential information may be securely communicated over network 130 and only made available to a designated destination.

Reference is made to FIG. 1B that shows a high level block diagram of an exemplary computing device 190 according to embodiments of the present invention. For example, subscriber devices 120A and 120B may be or include devices such computing device 190. Likewise, server 110 may be or may include components of computing device 190. Computing device 190 may include a controller 135 that may be, for example, one or more central processing unit(s) (CPU), chip(s) or any suitable computing or computational device, an operating system 140, a memory 145, a storage 162, input devices 161 and output devices 160. Operating system 140 may be or may include any code segment designed and/or configured to perform tasks involving coordination, scheduling, arbitration, supervising, controlling or otherwise managing operation of computing device 190, for example, scheduling execution of programs. Operating system 140 may be a commercial operating system. Memory 145 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 145 may be or may include a plurality of, possibly different memory units.

Input devices 161 may be or may include a mouse, a keyboard, a touch screen or pad or any suitable input device. It will be recognized that any suitable number of input devices may be operatively connected to computing device 190 as shown by block 161. Output devices 160 may include one or more displays, speakers and/or any other suitable output devices. It will be recognized that any suitable number of output devices may be operatively connected to computing device 190 as shown by block 160. Any applicable input/output (I/O) devices may be connected to computing device 190 as shown by blocks 160 and 161. For example, a network interface card (NIC), a printer or facsimile machine, a universal serial bus (USB) device or external hard drive may be included in input devices 161 and/or output devices 160.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 145 and a controller such as controller 135.

Some embodiments of the invention may be provided in a computer program product that may include a non-transitory machine-readable medium, stored thereon instructions, which may be used to program a computer, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time. Although not shown in FIG. 1B, client module 121 may be loaded into memory 145 and executed by controller 135.

As shown, detection application 150, transaction data 151 and logic 152 may be loaded into memory 145, for example, by controller 135. Detection application 150 may use logic 152 to process transaction data 151. For example, controller 135 may extract logic 152 from one of NLUs 127 or from one of PNMs 129 and load extracted logic into memory 145. Transaction data 151 may be obtained by controller 135 and loaded into memory 145. For example, transaction data 151 may be any data related to a transaction that may be sent or received by computing device 190 over network 130 (e.g., using I/O devices 160 and 161), may be captured by controller 135 and loaded into memory 145. For example, transaction data 151 may include data such as a sum (e.g., an amount of currency or securities), a date and/or a source and destination related to a financial transaction. Detection application 150 may be executed by controller 135 to process transaction data 151. For example, detection application 150 may analyze transaction data 151 based on logic 152 to detect a risk or threat in a transaction related to transaction data 151. Logic 152 may be replaced or updated as required. Detection application 150 and/or logic 152 may be a set of instructions, e.g., computer-executable instructions, which, when executed by controller 135, carry out methods disclosed herein. Accordingly, a detection system or engine may include controller 135 and detection application 150. Such detection system may be provided with logic such as logic 152 to process or analyze a transaction, e.g., by processing transaction data 151.

Detection system 122 may be any system, component, unit or module configured to detect specific events. Specifically, detection system 122 may be any component capable or configured to detect various fraudulent activities or scenarios, e.g., fraudulent transactions. Detection system 122 may be configured to monitor or track transactions, analyze various parameters and data in such transactions and determine a risk related to monitored and/or analyzed transactions. For example, detection system 122 may be a controller (e.g., controller 135 shown in FIG. 1B) and (or executing) an application (e.g., detection application 150 shown in FIG. 1B) configured to detect a threat or risk related to a transaction, e.g., by analyzing or processing data related to the transaction (e.g., transaction data 151 shown in FIG. 1B). Detection system 122 may interact with various systems or components to obtain information related to a transaction. Detection system 122 may be configured to monitor a transaction performed by the associated device (or by devices associated with the device; e.g., operated by the organization or company controlling detection system 122), e.g., a monetary transaction initiated by device 120B or a monetary transaction in which device 120A participates, or a transaction where devices 120A or 120B are given data to analyze. In some embodiments, e.g., by interacting with remote systems, detection system 122 may monitor transactions that may not be related to a specific device. For example, detection system 122 on device 120B may, by interacting with a remote system, monitor and/or analyze a transaction related to a specific client, establishment or product even though such monitored transaction are unrelated to device 120B. For example, detection system 122 on device 120B may monitor transactions in order to identify, determine or detect risks related to the transactions. Detection system 122 may operate based on one or more NLUs or other data structures. As further described herein, an NLU including detection, prevention or other logic or rules may be loaded into or stored on a detection system 122 and a detection system 122 may detect or determine a risk in a transaction based on logic in a loaded NLU. Other functionalities of detection system 122, e.g., finding dependencies between a number of NLUs, exporting and importing NLUs, exporting subscriber's usage data and or incident data are further described herein. For example, usage data may refer, or be related to, threats that were detected by logic that may be included in an NLU or a PNM. Incident data may refer or be related to threats that were not necessarily detected, and for which, detection or prevention logic may have not been yet generated and/or included in an NLU or PNM.

According to embodiments of the invention, a detection system may operate based on parameters, logic or rules, information or data included in one or more NLUs. Accordingly, a detection system may be a configurable platform that may be made to operate or function according to one or more NLUs that may be downloaded from a server or otherwise shared. For example, subscriber B may download one or more NLUs from server 110 to subscriber B device 120B in order to cause detection system 122 on device 120B to perform according to parameters included in such downloaded NLUs. Accordingly, subscribers to network 130 may not only share information related to fraud or other risks but may further share actual and executable logic usable in detecting and combating risks, frauds or other undesirable aspects related to digital transactions. In some embodiments, a detection system 122 may be an engine executing logic, rules, or other NLUs 127 parameters, to process data (e.g., financial transaction data, worm or virus activity data, e-mail data) and detect threats.

An NLU (e.g., one of NLUs 127) may be any construct that includes detection and/or prevention logic or rules. An NLU may be specific to a detection system. For example, the format of an NLU may be determined by the target or source detection system. For example, an NLU may be generated by causing a detection system to export logic. Exported logic from a first detection system may be in the form of an NLU that may subsequently be imported, e.g., into a second detection system. Accordingly, the format or other relevant aspects of an NLU may be determined based on the relevant detection system.

An NLU may include various fields. For example, an NLU may include an NLU identifier (NLUID) that may enable uniquely identifying the NLU as well as determining other attributes, e.g., the source or generator of the NLU (e.g., the detection system or user that generated the NLU associated with the NLUID), the date the associated NLU was last modified and the like. For example, an NLUID may be unique system wide, e.g., in some embodiments, no two NLUs in system 100 may have the same NLUID. For example, using various parameters that may be unique, e.g., a media access control address (MAC address) of the device used for generating the NLUID or a user provided code, embodiments of the invention may cause an NLUID to be unique. In other embodiments, an NLUID may be generated based on the content of the associated NLU. For example, an NLUID may be generated by processing text included in an NLU, e.g., an NLUID may be generated by compressing text in an NLU, for example, an NLUID may a compressed textual representation of an entire NLU or a predefined portion of the NLU.

An NLU may include a type field that may indicate the type of the NLU. For example, a type may identify an NLU as a computational, a storage, a configuration or as a private NLU. A computational NLU may include computation or context related details defining aspects or conditions such as when the computation would be executed, how input data for a computation would be determined and/or how the result of a computation would be used. A context may be defined in various ways. For example, the context may identify a specific point in a detection system's business logic. For example, in a detection system that processes transactions, the context may indicate that the computation is executed on every outbound wire transaction processed by the detection system. The context may further define that the input for the computation includes all data fields of the transaction, and the context may further define that the result of the computation is added as a new data field on the transaction for the purpose of further processing within the detection system or by another detection system.

Computation parameters in an NLU (e.g., included in a computational NLU) may define the expected input structure for the computation, and may indicate points in the detection system business logic where the computation can be used. In this manner, a computation in an NLU may be exposed within a detection system, e.g., as a function in a programmatic sense. For example, if a detection system allows users to define logic using a programming language such as structured query language (SQL), or Java or a proprietary language then, using computation parameters, the NLU may be used as a function within that language. In this usage, the details such as when the computation is executed, the input data, and how the result of the computation is used may all be implemented by the way they are used within the relevant computer programming language.

Computation parameters or data in an NLU (e.g., in a computational NLU) may define how a computation result is determined from the input data. For example, computation parameters or data may be a definition of a function in any programming language such as SQL, Java or a proprietary language, or a description of a predictive model such as a neural network. A computation in an NLU may reference other NLUs or the NLU itself, e.g., within a detection system or in other detection systems. For example, computation data included in an NLU may be:

```
<nlu nlu_type=“COMPUTATION” identity_key=“aab8d2df”>
  <context
  ctx_id=“ACT_FRD_PAYMENT_DETECTION_RULES”/>
  <computation>
```

<rule>payment_amount &gt; 100</rule>

</computation>
</nlu>

While specific examples of NLUs are disclosed herein, NLUs, rules and logic may be in different formats in accordance with various embodiments of the present invention. The above exemplary computation data may be a textual representation of a computation included in an NLU that defines a computation of a simple detection rule on a payment event. The exemplary computation data returns true if the payment amount is greater than 100.

A storage NLU may include parameters or data such as a data structure parameter, definition or information that may define a structure of stored data. For example, data structure information in an NLU may define a set of named and/or typed fields (e.g., similar to structure information as used in a relational database table as known in the art). A storage NLU may include context related information, e.g., information defining when and/or how, stored information (e.g., information related to a transaction) would be stored. For example, the update context or information in an NLU may indicate that stored information is updated whenever an outbound wire transaction is processed by the detection system, mapping specific transaction fields to the storage fields, e.g., as defined in a related data structure section of the NLU. A storage NLU may include a purge policy definition or information. For example, parameters or a policy may define a time or event that may indicate stored data is to be invalidated (and/or should not be provided to an application or to the detection system executing the NLU). Invalid data may be purged and/or overwritten by the detection system. For example, a purge policy may define a boolean condition related to some stored data fields or records such that any data record for which the boolean condition is true may be purged.

For example, storage data or logic included in an NLU may be:

<nlu nlu_type=“STORAGE” identity_key=“abf675da”>

<data_structure>

<field id=“payee_name” type=“string”/>
<field id=“transaction_date” type=“date”/>
<field id=“payment_amount” type=“float”/>

</data_structure>
<update_context ctx_id=“ACT_FRD_PAYMENT_EVENTS”/>
<purge_policy days_to_keep=“30”/>
<other_data storage_id=“storage1”/>

</nlu>

The above exemplary storage logic may be a textual representation of a condition that defines that storage of three specific fields of all payment events is to be kept for thirty (30) days.

A configuration NLU (e.g., included in a configuration NLU) may include any relevant configuration parameters, data or information. For example, a configuration NLU may include parameters defining the structure of data that is exposed to users of a detection system and/or to external systems. For example, configuration parameters may define a set of named and typed keys, where each key may be assigned a value or multiple values of the specified data type by the user. A single key may sometimes be assigned a set of structured values. For example a watch list of suspicious entities may be assigned a set of entities, each having an entity identification, a “from date” and a “to date” or other configuration parameters that may be used to determine how, when or other conditions for monitoring entities included in the watch list or processing data related to such entities.

A configuration NLU may include default value. For example, values or other attributes assigned to data, parameters or fields generated by an NLU or imported by an NLU may be determined based on a configuration default value in a configuration NLU. Generally, default values defined by configuration data may be assigned to any parameter if the specific value or other attribute of the parameter is unknown and, possibly, if one or more conditions are met (e.g., the parameter was loaded into the NLU without sufficient information to determine it's value or another attribute). For example, default values may determine values of parameters in an NLU imported into a detection system instance (e.g., before the NLU is modified by a user, by a detection system by or external system). For example, a configuration NLU describing a watch list of suspicious entities may include a complete list of specific suspicious entities as a default value. Default values included in a configuration NLU may constitute any portion of the detection logic included in an NLU. For example and as shown below, default values included in a configuration NLU may be a list of suspicious payees, including a name and effective date for each of the suspicious payees.

<nlu nlu_type=“CONFIGURATION” identity_key=“def1d2ab”>

<data_structure>
<field id=“suspicious_payees” type=“list”>

<field id=“suspicious_payee_name” type=“string”/>
<field id=“effective_date” type=“date”/>

```
  </field>
</data_structure>
<default_values>
  <field id=“suspicious_payees”>
```

```
<value>
  <field id=“suspicious_payee_name” value=“John Doe”/>
  <field id=“effective_date” value=“2007/01/01”/>
</value>
<value>
  <field id=“suspicious_payee_name” value=“Jane Doe”/>
  <field id=“effective_date” value=“2008/02/01”/>
</value>
```

</field>
</default_values>

<other_data configuration_id=“conf1”/>
</nlu>

An operation of a detection system may be based on or by executing or processing one NLU or a number of NLUs. Accordingly, interdependencies between NLUs may exist. For example, a computational NLU may depend on (and accordingly include a reference to) a configuration NLU. For example, the text below is an exemplary text representation of a computational NLU that depends on a configuration NLU for its operation or execution.

```
<nlu nlu_type=“COMPUTATION” identity_key=“ffabcda2”>
  <context
  ctx_id=“ACT_FRD_PAYMENT_DETECTION_RULES”/>
  <computation>
```

<rule>(payment_amount &gt; 1.5*(select

avg(storage1.payment_amount) from storage1 where
storage1.payee_name =
payee_name)) or (select count(*) from conf1 where
conf1.suspicious_payee_name=payee_name and conf1.effective_date
&lt;= transaction_date) &gt; 0</rule>
</computation>
</nlu>

In the example above, an NLU (identified as “ffabcda2”) defines a computation for a detection rule on payment events using the storage NLU identified as “storage1” and a configuration NLU identified as “conf1” (both defined in the examples above). As shown, the computational NLU returns true if the payment amount is greater than 1.5 times the average stored payment amount for the same payee name, or if the payee name is in the suspicious payee list with a current effective date.

According to embodiments of the invention, one or more NLUs may be packaged into a data structure such as a packaged network model (PNM). A PNM may include a number of NLUs and any other data or parameters. Including NLUs in a PNM may include any representation of the included NLUs in a PNM. For example, when exporting NLUs from a source detection system, exported NLUs may be converted from a first representation into a second representation and the second representation may be included in the PNM. In such case, when importing NLUs into a target PNM, the representation of the imported NLUs in the PNM may be converted to a different representation that may be used for importing or loading the NLUs into the target detection system.

In addition to logic or other information related to NLUs, a PNM may include other parameters. For example, a PNM may include a protocol or version number or any other identifier that may be used in order to manage or maintain compatibility aspects. For example, a subscriber using an old version of a detection system (e.g., detection system 122) may still upload data to a host or server (e.g., server 110) since the host may recognize that the uploaded data is formatted according to an old protocol or version based on the protocol or version number, and, accordingly, the server may properly interpret uploaded data. Other parameters or information in a PNM may be, for example, a date and time when the PNM was generated (e.g., exported from a detection system), a name (e.g., free format text), comments (e.g., additional descriptive text), any information related to the detection system from which the PNM was exported, version information (e.g., information identifying compatibility of the PNM with detection system versions), a list of NLUs included in the PNM and the like.

For example, the text below is an exemplary code segment representing a PNM that includes NLUs described herein:

<?xml version=“1.0” encoding=“utf-8”?>
<pnm protocol_version=“1.0” export_datetime=“2009/01/01 12:34PM GMT-2”
name=“Suspicious payment transaction” description=“This rule triggers if the payment
amount is greater than 1.5 times the average stored payment amount for the same payee
name, or if the payee name is in the suspicious payee list with a current effective date.”
ds_type=“ACT_FRD” ds_min_version=“2.0”>
<nlus>
<nlu nlu_type=“COMPUTATION” identity_key=“ffabcda2”>

<context ctx_id=“ACT_FRD_PAYMENT_DETECTION_RULES”/>
<computation>

<rule>(payment_amount &gt; 1.5*(select avg(storage1.payment_amount)

from storage1 where storage1.payee_name = payee_name)) or (select count(*) from
conf1 where conf1.suspicious_payee_name=payee_name and conf1.effective_date &lt;=
transaction_date) &gt; 0</rule>

</computation>

</nlu>
<nlu nlu_type=“CONFIGURATION” identity_key=“def1d2ab”>

<data_structure>
<field id=“suspicious_payees” type=“list”>

<field id=“suspicious_payee_name” type=“string”/>
<field id=“effective_date” type=“date”/>

```
  </field>
</data_structure>
<default_values>
  <field id=“suspicious_payees”>
```

```
<value>
  <field id=“suspicious_payee_name” value=“John Doe”/>
  <field id=“effective_date” value=“2007/01/01”/>
</value>
<value>
  <field id=“suspicious_payee_name” value=“Jane Doe”/>
  <field id=“effective_date” value=“2008/02/01”/>
</value>
```

</field>
</default_values>

<other_data configuration_id=“conf1”/>
</nlu>
<nlu nlu_type=“STORAGE” identity_key=“abf675da”>

```
<data_structure>
  <field id=“payee_name” type=“string”/>
  <field id=“transaction_date” type=“date”/>
  <field id=“payment_amount” type=“float”/>
</data_structure>
```

```
  <update_context ctx_id=“ACT_FRD_PAYMENT_EVENTS”/>
  <purge_policy days_to_keep=“30”/>
  <other_data storage_id=“storage1”/>
</nlu>
</nlus>
</pnm>
```

A detection system may be used to create and to export one or more NLUs. For example, exported NLUs may be packaged in a structure such as a PNM that may be stored, e.g., locally or may be uploaded to a server. For example, detection system 122 on device 120B may export a number of selected (e.g., by a user operating device 120B) NLUs into a PNM and further upload the PNM to server 110. A user operating device 120A may download the PNM from server 110 and import the PNM (and/or included NLUs) into detection system 122 on device 120A. To export one or more NLUs, e.g., in the form of a PNM, client module (or another module) may enable a user to select the NLUs to be exported. A detection system may generate a textual or other representation of the selected NLUs and include the representation of the NLUs in a PNM that may be stored, e.g., as one of PNMs 129 on storage 125B as shown. One or more of PNMs 129 on storage 125B may be uploaded (e.g., by a user or by detection system 122) to server 110. NLUs, rules, and logic need not be stored in PNMs.

NLUs to be exported may be retrieved from a local storage. For example, an NLU (e.g., one of NLUs 127) may be retrieved by detection system 122, converted to a predefined format, included in a PNM and stored on storage 125B, e.g., as shown by PNMs 129. As described, a PNM may include any information that may be required, e.g., by another detection system that may import the exported NLUs. For example, a PNM may include any parameters needed to establish references or dependencies between NLUs. For example, internal identifier of NLUs used to establish or manage references between objects or NLUs may be converted to text or other format that may be understood by a receiving or target detection system, e.g., a detection system that subsequently imports NLUs in a PNM, such that the receiving or importing detection system may correctly establish, maintain or manage cross references between NLUs.

According to embodiments of the invention, a user may select NLUs to be exported. For example, client module 121, detection system 122 or a graphical user interface (GUI) tool may enable a user to browse NLUs (e.g., stored on storage 125A as shown by NLUs 127 and/or packaged in one of PNMs 129) and select one or more NLUs to be exported or included in a PNM. An “export NLU” function may be invoked for one or more selected NLUs, and the function may be provided with parameters such as PNM name to be created or updated with the selected NLUs. Other parameters provided by a user when invoking a creation of a PNM to include exported NLUs may be a name of the PNM, descriptive text, version related information and the like. Some information provided by the user or otherwise obtained may be included in a PNM such that it may be displayed, e.g., by server 110 to users who may wish to download the PNM. Information associated with a PNM may be used in searching NLUs. For example, a search may be based on a tag (e.g., associated with an uploaded item by a creator of the item, e.g., a subscriber exporting an NLU as described herein may associate an exported NLU with a tag). A search may be based on a data type (e.g., an NLU, a PNM or a specific dashboard). A dashboard may be or may include a graphical presentation of information presented to a user, possibly utilizing various graphical objects such as dials, graphs and the like. A search may be based on matching text provided by the searcher (e.g., in a search box) to text associated with downloadable items. For example, search text provided may be matched with a comment, a name or a description associated with an NLU or PNM in order to find such items. Likewise, one or more of a rating attribute, version history, a time parameter (e.g., creation, export or usage period) may be used as search parameters, e.g., received from a user searching for items and matched with stored items.

For example, based on criteria provided by a user searching for an NLU, PNMs or NLUs stored and/or maintained by server 110 (e.g., as shown by 112 and 116) may be searched, e.g., by examining associated metadata that may be information provided by creators of the PNMs. Accordingly, a user exporting NLUs, e.g., by generating a PNM, may add any descriptive or other information that may subsequently be used when searching for NLUs. For example, a user may provide identifications of threats, a specific type of malware such as a specific version of a Trojan that may be detected or blocked by NLUs in a PNM and such description may be associated, e.g., as metadata, with the PNM. Accordingly, when searching for NLUs to combat the specified threats, server 110 may find relevant PNMs based on, for example, associated metadata. Upon completing a selection of NLUs for export and providing any additional parameters, a list of the NLUs to be exported may be presented to a user, and, upon receiving a confirmation from a user, the NLUs may be exported, placed in a PNM and uploaded to a server. Data exported by a detection system instance and uploaded to a server may be digitally signed by the detection system instance. The signature may be verified by the receiving server thus guaranteeing that the uploaded data is identical to the exported data.

Data, information or parameters other than or associated with NLUs or PNMs may be uploaded to a server or otherwise shared. For example, users or subscribers (e.g., subscribers to network 130) may upload ratings, version history, comments, usage and incident data to a server and such uploaded information may be shared or kept private. For example, usage and incident data may be classified as private data that may not be shared. In some embodiments, version history may be maintained by a server (e.g., server 110). Ratings, tags, version history, comments and other data posted by subscribers, typically in relation to a specific published data item may be stored as community metadata as shown by 113. For example, a user may rate an NLU or other logic or rules. Client module 121 may enable (e.g., using an associated GUI tool) a user to browse through some or all NLUs stored on a device (e.g., NLUs 127 and/or packaged in one of PNMs 129), select or create a rating (e.g., a number from 1 to 5, a letter grade, a verbal category, etc.) for a specific NLU and post the rating to server 110 where the rating may be made available to other subscribers of network 130. Client module may similarly enable a user to post a comment. For example, a user may browse NLUs on a device, associate a comment with an NLU and post the comment, e.g., via sever 110. Comments may be made available to other users, e.g., subscribers to network 130. Usage data may similarly be posted, e.g., similarly to posting a rating as described herein. A rating may be related to a specific aspect or it may be a general rating. For example, a user may rate a logic by pressing one of a “Like” and “Dislike” buttons to rate a logic, or one of a “thumb up” or “thumb down” icons may be pressed in a GUI screen provided by client module 121. In other embodiments, a rating may be performed by selecting a number, e.g., from 1 to 5 where 1 may indicate a low rating and 5 may indicate a high rating or mark. A rating may be captured, e.g., by client module 121 and sent to a server (e.g., server 110) that may aggregate ratings and display aggregated ratings to subscribers in a community. Ratings may relate to the actual effectiveness of the NLU, rule or logic (e.g., false positives, accuracy in detecting fraud, money saved or recovered, etc.)

Data uploaded to server 110 may be private or public and may be stored accordingly, as shown by private network data 114 and public network data 115. For example, private data uploaded may be used anonymously, e.g., in compiling statistical reports or graphs, present ratings and the like, however, private data itself may not be provided to subscribers nor may the name or other identifying information of the subscriber be disclosed. In contrast, public network data may be distributed or otherwise provided. For example, public data may be data generated by server 110 (e.g., various statistics, reports, graphs and the like). Public data may further be generated by users or subscribers. For example, client module 121 may enable a subscriber to tag uploaded data as either public or private. Accordingly, data tagged as private may be stored as private data and server 110 may not enable sharing of such private data while data tagged as public may be freely shared.

For example, usage data may include a PNM's name, a type of detection system in conjunction with which NLUs included in a PNM were used, a time period during which the PNM was used by the user, threats detected (or successfully detected) by NLUs included in the PNM and the like. For example, usage data may indicate whether the included NLUs are designed for detecting frauds related to a person, an account, a specific transaction, company, a physical address, an IP address, a virus, a worm, an automated teller machine (ATM), a point of sale (POS) device etc. Any information that may be relevant to the operation of an NLU and/or that may help other users in searching or evaluating an NLU may be uploaded and shared. Accordingly, embodiments of the invention may enable aspects similar to those found in social networks as applied to combating threats. Uploading information (e.g., a rating or usage or incident data) may include invoking, e.g., by client module 121, an export data function that may graphically enable a user to browse through NLUs or other relevant items, receive a selection and/or text from the user, present selected items and/or information to be exported, receive a confirmation and upload information to a server. Incident data may be uploaded from a device operated by a subscriber (e.g., subscriber A device 120A) to a server (e.g., server 110). For example, incident data may include information related to threats or risks for which no specific logic was developed.

According to embodiments of the invention, a number of detection systems may be deployed or executed on a single device. In other embodiments, a single subscriber may own and/or operate a number of computing devices. In such cases or configurations, each detection system may be assigned a different identification, e.g., a different name and any operations described herein may be associated with a specific detection system. For example, exporting NLUs, PNMs or usage or incident data may be performed in the context of a specific detection system. In other cases or contexts, operations related to multiple detection systems may all be performed in the context of the user. Any operation performed by a user or involving a user may be performed using command line interface, or any other suitable application, scheme or mechanism.

For example, to upload and/or download logic to/from a network, subscribers (e.g., subscribers operating devices 120A and 120B) or modules (e.g., client module 121) may use any suitable method, system or protocol, e.g., a protocol intended for exchanging structured information in a decentralized or distributed environment. Exemplary technologies used may be extensible markup language (XML) or other technologies which may enable a messaging framework that may be supported by a variety of protocols, e.g., SOAP. In some embodiments, exporting data may be automatically performed. For example, usage or incident data may be periodically and automatically exported, e.g., by client module 121 based on one or more configuration parameters.

Any data uploaded to a server (e.g., server 110) may be examined by the server or by operators of the server (e.g., employees of the entity operating the server) and, based on the examination, various operations may be performed. For example, uploaded content (e.g., a PNM or feedback related to risk detection logic, for example, a rating) may only be accepted if one or more criteria are met. Server 110 may examine each uploaded NLU (e.g., by extracting NLUs from a PNM). Server 110 may determine whether an NLU already stored in storage 111 is identical to a previously uploaded (or already stored on storage 111) NLU. If an identical NLU is not found, the server may store an uploaded NLU and assign it a server identification code. If an uploaded NLU is determined to be identical to an NLU already stored at the server then the server identification code of the existing NLU may be noted and a table may be updated to note that duplicated items are stored. For example, if a first received PNM includes NLUs 1 and 2 and a second PNM includes NLUs 2 and 3 where NLU 2 included in the two PNMs is the same NLU then server 110 may only store NLUs 1, 2 and 3 and note that NLU 2 is included in both PNMs. For example, pointers associated with both PNMs may point to the same stored NLU 2.

Any information associated with an uploaded PNM may be stored by the server. Other information may be obtained and stored. For example, server 110 may examine an uploaded PNM and store, in association with the PNM, a list of NLUs included in the PNM. For example, ratings and comments provided by users may be stored in association with the relevant NLUs or PNMs and made available to users or subscribers. An operation of a server may be according to any applicable configuration parameters. For example, an administrator may set subscriber accounts and their permissions, or accounts permissions, designate various items as public or as available only to specific groups or types or users, set upload and download permissions (e.g., per user or per item) and the like. In addition, any data uploaded to a server may be subject to review and approval by a host or server administrator before it becomes visible to any subscriber.

Access to a server management may be secured, e.g., using secure sockets layer (SSL) connections, secure file transfer protocol (FTP), secure hypertext transfer protocol HTTP or an equivalent protocol, encrypting data and the like Likewise, uploading and/or downloading information to/from a server may be done using any security measures known in the art. Generally, a network such as network 130 may be a secured subscriber network, access to which may only be permitted to subscribed (and possibly authenticated) users. For example, prior to enabling a user to upload or download information, server 110 may authenticate the user, exchange encryption keys and/or perform any security related operations. Server 110 may log or record any information related to communication of data or interaction with other devices or users. For example, a log maintained by server 110 may include a subscriber identification usable to identify a user or subscriber, a detection system instance identification (which may be provided by client module 121), date and time of an interaction, a request type (e.g., download, search or upload), and any details or parameters related to an interaction with the server.

Some of the exported and/or uploaded information, parameters and items may be available to users or subscribers. For example, some of the data uploaded by a first user or subscriber may be made public to all other subscribers.

Embodiments of the invention may enable a user or subscriber to search for content based on various criteria. For example, a user may search for NLUs and/or PNMs using a GUI tool that may execute on a user device and interact with a server. For example, a GUI tool executed on subscriber device 120A may interact with server 110, may provide user search criteria to server 110 and server 110 may use user criteria to present a list of NLUs and/or PNMs that meet the criteria.

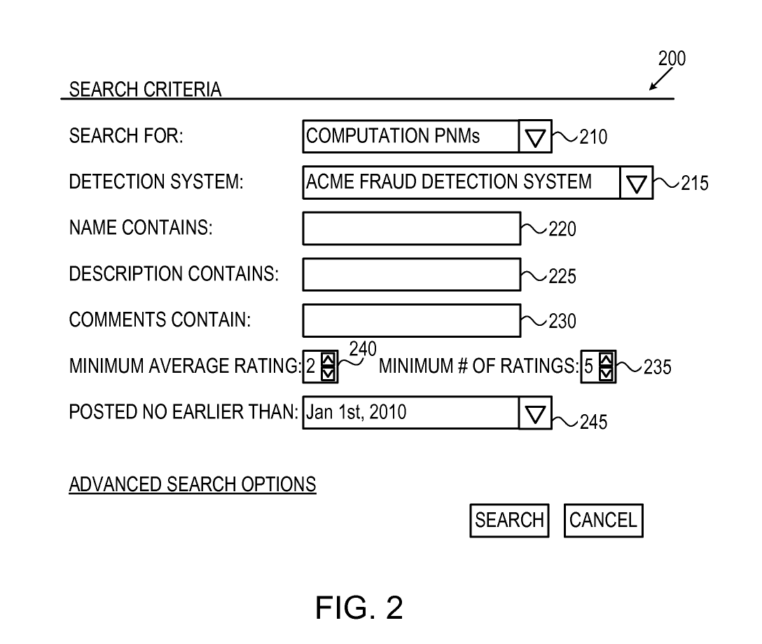

Reference is made to FIG. 2, an exemplary screen display 200 according to embodiments of the invention. As shown by 210, a user may indicate the type of public network data (e.g. PNM) to search for. For example, a computation, configuration or storage PNM may be selected as the PNM type to search for. As shown by 215, the type of detection system may be selected. As described herein, various types of detection systems may be supported by embodiments of the invention, accordingly, a user may indicate the type of detection system used so that only NLUs or PNMs suitable for the detection system used will be searched for and suggested for download. As shown by 220, the name of a PNM or NLU (or part of the name) may be provided as input to a search operation. Accordingly, a list of NLUs or PNMs associated with a name that contains a provided string may be provided. As shown by 225, text related to a description of an item may be provided. Text related to a description may be used (e.g., by server 110) to search for NLUs or PNMs associated with a description that matches the provided text. For example, a description provided by a user when uploading a PNM may be examined and matched with text provided by a user as shown by 225. As shown by 230, NLUs or PNMs may be searched based on comments provided by users when exporting NLUs using text provided as shown by 230. If a match between text provided in box 230 and a comment associated with an NLU or PNM is found, the NLU or PNM may presented and/or offered for download.

As shown by 240, NLUs or PNMs may be searched based on a rating. For example, a user may request to be presented only with NLUs or PNMs associated with an average rating above a specific value. As shown by 235, NLUs or PNMs may be searched based on the number of ratings. For example, a user may request to be presented only with NLUs or PNMs associated with at least a minimum number of ratings. For example, a user may indicate that only NLUs that were rated by at least 20 users are to be presented, listed or displayed. Any combination of search criteria may be supported. For example, a user may want to be presented with NLUs or PNMs that are both associated with a minimum number of ratings and further with an average rating above a specific value. As shown by 245, a criteria related to a time an NLU or PNM was exported, posted or otherwise made available may be enabled. Accordingly, a user may select to only be presented with NLUs or PNMs posted no earlier than a specific date. Search results may be provided, e.g., to client module 121 that may, possibly using a GUI tool, present results to a user. A client module may buffer results received from a server and provide buffered results, e.g., when a “Next Page” button is pressed.

Information received from users or subscribers or other sources may be used, e.g., by server 110, in order to provide users with various views graphs or reports, e.g., in the form of dashboards. Other formats may be used. For example, client module 121 may enable a user to select a report or dashboard, and, based on the report or dashboard selected, interact with server 110 to obtain relevant information and present obtained information to a user.

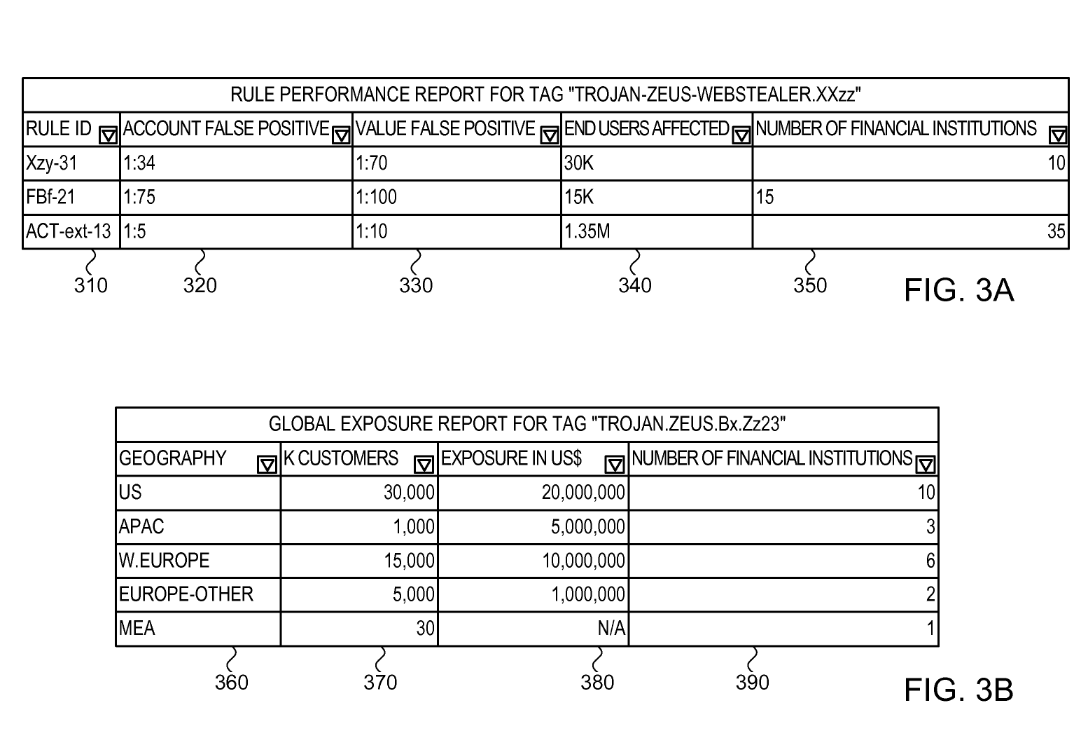

Reference is made to FIG. 3A, an exemplary screen display related to a report, according to one embodiment. As shown, a report may provide information on various aspects related to a specific threat (as indicated by the malware name “Trojan-Zeus-Webstealer.XXzz”. A report may be per rule. For example, a report may provide information with respect to a number of logical rules or rule sets that may be implemented by logic in one or more NLUs. As shown by 310, the names of the rules may be displayed, and thus a user may later search for a specific rule, e.g., based on determining the performance of the rule is desired. As shown by 320, the number of false positive detections (e.g., wrongly determining a threat) may be listed per each rule. As shown by 330, the number of false positives. For example, false positives may be determined according to account false positive rate and/or according to value false positive rate as known in the art. Similarly, false negatives may be presented (e.g., the number of cases in which a rule failed to detect a threat).

As shown by 340, the number of users affected by the threat may be shown. As shown by 350, the number of affected institutions may be shown. Any information gathered by server 110 may be used to define reports, accordingly, it will be understood that various other reports are enabled by embodiments of the invention and the report shown in FIG. 3A is only one example of a large number of possible reports.

Reference is made to FIG. 3B, an exemplary screen display related to a report according to one embodiment. The report shown by FIG. 3B shows additional information that may be displayed. As shown by 360, a report related to a threat (“Trojan-Zeus-Bx.Zz23” in this case) may provide geographic information for the threat in the form of geographic areas affected by the threat. As shown by 370, the number of customers (here expressed in thousands) affected by the threat may be shown. As shown by 380, a total monetary value affected by the threat in each region may be displayed, expressed for example in US dollars.

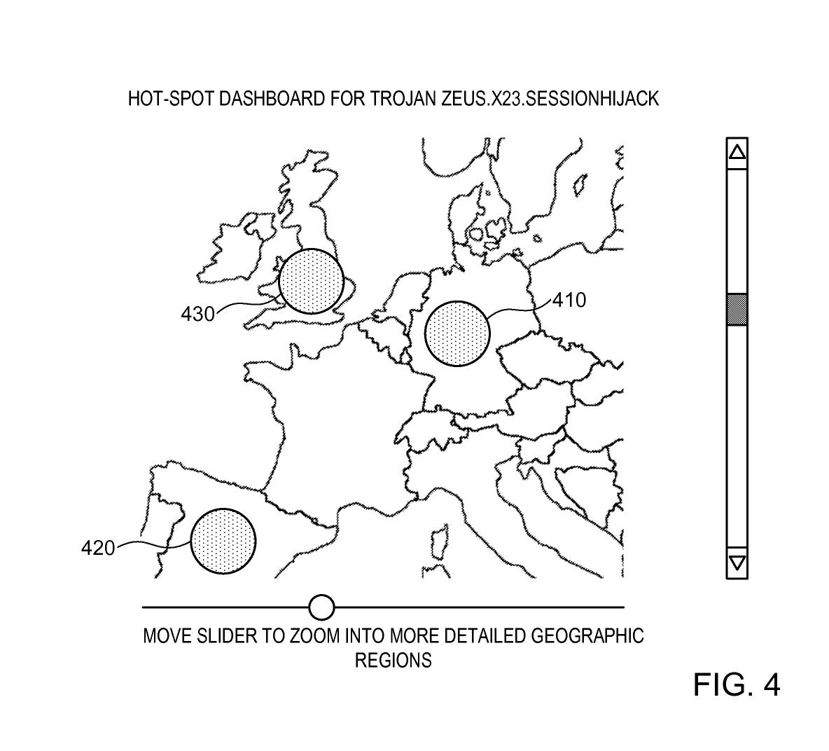

As shown by 390, the number of affected financial institutions affected may be shown. Reference is made to FIG. 4, an exemplary screen display according to embodiments of the invention. As shown by 410, 420 and 430, hot-spots indicating geographic regions most affected by a threat (trojan “Zeus.x23.sessionhijack” in this case) may be indicated. A report or dashboard may be dynamic. For example, client module 121 may obtain initial information from server 110 and display the information to a user as shown by FIG. 3A, 3B or 4. Client module may further periodically (e.g., based on a configuration parameter) retrieve new information (if available) from server 110 and update the displayed report, accordingly, a user may be provided with online or real-time reports. For example, the reports shown by FIGS. 3A, 3B and 4 may all be dynamic and may be updated according to any selected time resolution.

Based on reports, search results or otherwise, a user may select to download an NLU or a PNM. Based on a user request, server 110 may search stored PNMs or NLUs (e.g., as shown by 112 and 116) and provide requested items for download. Prior to enabling a user to download items, server 110 may verify the user may download content. For example, server 110 may prompt a user to provide a password or may otherwise authenticate a user. In other cases, server 110 may check if a subscriber is entitled to download items based on configurable policies. For example, a policy may restrict download of some items by subscribers that did not upload usage data within a recent period. Content may be downloaded in one of many forms, e.g., based on a selection. For example, an entire PNM may be downloaded or a specific NLU may be downloaded. In the latter case, server 110 may extract a specific NLU from a PNM and provide the extracted NLU to a user, e.g., by placing the requested item in a predefined folder or location and informing client module 121 where the item is located such that client module 121 may retrieve the item, e.g., using secured FTP or another suitable protocol.

A PNM uploaded to server 110 by a first detection system may be downloaded and imported by a second detection system. (Uploading and downloading is typically done via a network, e.g., network 130.) For example, PNMs 129 on storage 125A may have been downloaded from server 110 (e.g., they may be some of PNMs 112 stored on storage 111). PNMs 129 on storage 125A may be imported into detection system 122 on device 120A. Detection system 122 may examine NLUs included in a PNM, e.g., to determine whether identical or conflicting NLUs are already included in a working set of NLUs used by detection system 122. For example, an internal or other state of a detection system may be based on information in an NLU. Information in a state of a detection system may include, for example, a working set or a list of NLUs according to which a detection system is operating. Accordingly, prior to adding an NLU into a working set, the detection system may verify the NLU is not already included in its working set or verify logic included in an NLU does not conflict with logic in other NLUs in a working set. Upon completing any required verifications, NLUs in a PNM downloaded from network 130 may be imported, e.g., included in a working set of NLUs.

Importing NLUs (e.g., delivered in the form of a PNM) may include processing. For example, a detection system may analyze downloaded or otherwise obtained NLUs to determine any or which additional NLUs that an analyzed NLU depends on or otherwise associated with and further determine such additional NLUs are available (e.g., in the same PNM). For example, a downloaded computational NLU may depend on an additional, e.g., storage or configuration NLU, and may not function properly unless the additional NLU is available. Accordingly, a dependency graph related to a set of NLUs may be determined, possibly prior to actually importing a set of NLUs, and, provided that all NLUs or logic is available, the import process may be performed.

Once an NLU, or other logic or rules are imported, a detection system, being executed on a subscriber or user device, may operate according to the NLU, or execute the NLU, to detect threats. Threats may be detected by analyzing data (e.g, financial data, transaction data), the activity or malware, etc. in light of NLUs.

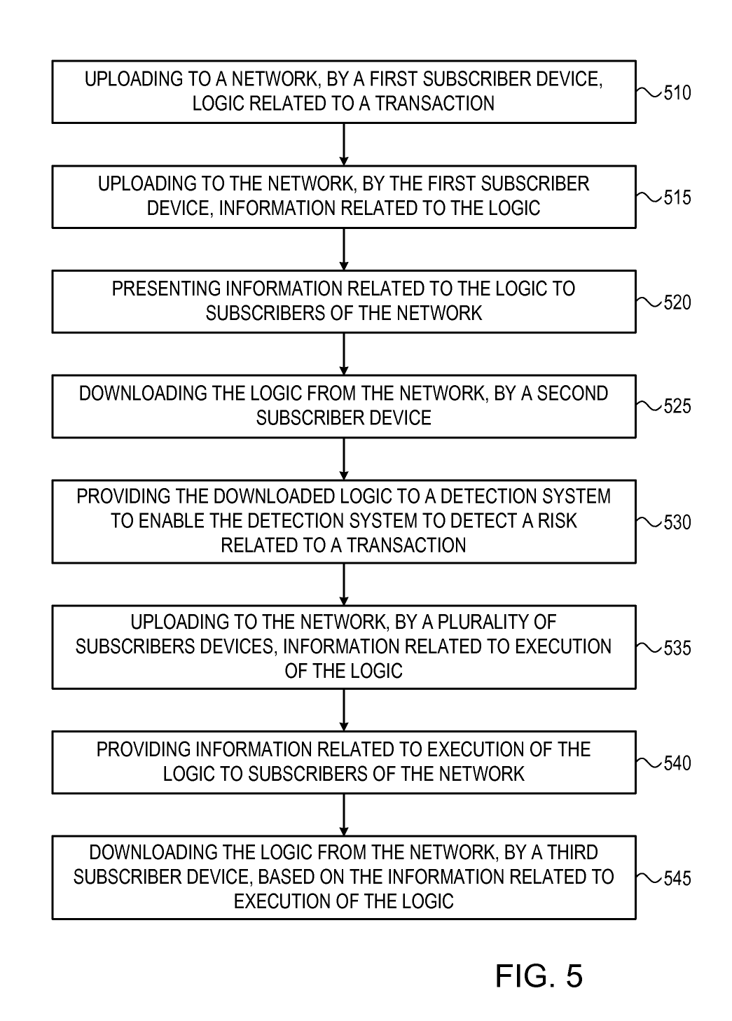

Reference is made to FIG. 5, a flowchart describing a method of sharing risk detection logic according to embodiments of the invention. In one embodiment, the operations shown in FIG. 5 may be performed by the system shown in FIG. 1A. In other embodiments, other systems may perform the operations of FIG. 5. As shown by block 510, the method or flow may include uploading to a network, by a first subscriber device, rules or logic related to a transaction (e.g., in the form of an NLU, but other forms may be used). For example, a logic related to a transaction may be logic usable in detecting a fraudulent financial transaction. Logic related to a transaction loaded to a network may include an implementation or representation of one or more rules or criteria that may be used in detecting a fraudulent financial transaction. Logic loaded to a network may include a set of conditions that, when met, indicate a transaction may be related to money laundering activity or other financial frauds. Any logic related to financial risk management may be included in logic uploaded to and downloaded from, a network. Likewise, logic uploaded to a network, rated and shared by a community of subscribers may be related to other threats or risks, e.g., viruses, worms or any malware or hostile software.

For example, a logic uploaded may include a set of conditions such as an amount of money being transferred, a time of day, or day of the week on which the transaction is made, a source and/or destination of the transaction, an institution associated with the transaction (e.g., a name of a bank) etc. Logic uploaded may include or indicate an action. According to embodiments of the invention, logic uploaded as described may (e.g., when executed, or when processed by a process such as a detection system) apply conditions to a transaction and, if conditions are met, cause one or more actions to be performed or generate one or more indications. For example, logic uploaded as shown by block 510 may be loaded into a fraud detection system to cause the detection system to operate according to rules implemented or represented by the logic. Any suitable action may be included, defined and/or implemented by logic uploaded, downloaded or otherwise shared by subscribers to a network. For example, logic shared may include rules and associated operations related to gathering information and/or uploading information to a network. For example, an NLU may include executable logic that, when executed, gathers various statistics or other information related to an execution of the logic. For example, the number of risks detected, transactions blocked and the like may all be recorded based on operations defined in a risk detection logic. Likewise, uploading of information collected may be included in a logic shared, e.g., as described herein.

Generally, a detection system may be any system capable of detecting fraudulent transactions. Typically, a detection system may be a unit that may be provided with any required information, data or parameters related to or associated with a transaction and may further be configured to analyze provided information, apply rules, thresholds or criteria and determine whether a transaction meets a predefined set of criteria or rules. For example, Remote Banking Fraud Solution® is a detection system provided by NICE Actimize® capable of detecting fraudulent transactions. A detection system according to embodiments of the invention may be provided with any relevant information related to a transaction and may apply conditions implemented or represented by a logic to detect fraudulent transactions that meet criteria included in the loaded logic. Accordingly and to some extent, logic loaded as shown by block 510 may be viewed as a set of configuration parameters that, when provided or applied to, or loaded into a detection system may cause the detection system to operate according to the provided or loaded logic.

Logic related to a transaction may be related to a policy. For example, a policy may include a set of principles, rules, thresholds and criteria and an associated set of actions. For example, a first policy may dictate that transactions are never blocked (e.g., even if a rule indicates a transaction is most likely related to a fraud), accordingly, indications or alerts may be generated by a detection system enforcing the policy, however, transactions may never be blocked under such policy. A second policy may allow blocking suspected transactions. Accordingly, the same set of rules used when the first policy is enforced may be used but different actions may be associated with those rules. Accordingly, detection systems enforcing different policies may function differently.

Logic related to a transaction may be related to a regulation. For example, rules and actions included in, implemented or represented by a logic may be configured to enforce a regulation. For example, a regulation may be one dictated by an institution (e.g., a bank) by a state, by a treaty or by any applicable entity. Logic uploaded as shown by block 510 may be contained or included in any suitable object, e.g., a file. Logic uploaded as shown by block 510 may be, for example, a code segment written in any applicable programming language, e.g., Java, SQL or a proprietary language. Logic uploaded as shown by block 510 may be readily loaded into and/or executed by a detection system. For example, logic uploaded, e.g., logic included in an NLU or PNM uploaded as shown by block 510 may be provided to detection system 122 that may analyze or process transactions based on such provided logic. For example, logic uploaded as shown by block 510 may be a Java code segment and detection system 122 may be configured to parse and execute such Java code.

Logic uploaded as shown by block 510 (e.g., in the form of an NLU included in a PNM) may be generated by a subscriber device. For example, a GUI tool (e.g., included in client module 121) may enable a user to select a set of rules, criteria or conditions (e.g., amount of money being transferred, a time of day, a source and/or destination of a transaction etc.) and further indicate an action (e.g., block, alert, delay) to be performed if one or more conditions are met, a threshold is breached or the transaction fails to meet a criteria. The GUI tool may convert selections, indications and/or other input from a user to code or set of instructions that may be executed by a detection system, e.g., Java code. For example, the GUI tool may generate an NLU or logic or a rule based on user selections, indications and/or other input from a user. The GUI tool may generate or include executable code or an NLU produced based on user specified rules, criteria and actions in a file and the file may be uploaded as shown by block 510. Accordingly, embodiments of the invention may enable a user to create, define and/or generate an NLU or other logic or rules and upload the NLU to a network. In some embodiments, security experts may generate an initial set of NLUs (e.g., based on accumulated knowledge related to threats) and the set of initial NLUs may be provided and installed with a system, e.g., the system shown in FIG. 1A. It will be understood that detection logic shared by a community of subscribers as described herein may be generated by any entity using any method or system and that embodiments of the invention are not limited by the method or system used for generating detection logic uploaded, downloaded, rated, shared or otherwise manipulated and/or used as described herein.

As shown by block 515, the flow may include uploading to the network, by the first subscriber device, information related to the logic. For example, client module 121 may enable a user to upload information related to the logic to server 110. Server 110 may store uploaded information related to the logic, e.g., on storage 111 as shown by private network data 114 or public network data 115. As described herein, a subscriber may upload both private and public data. For example, private data or information uploaded as shown by block 515 may be specific details of transactions (e.g., names of banks involved in the transaction, amounts transferred etc.) or details identifying the subscriber or user uploading the information (e.g., address, name etc.). Public information uploaded as shown by block 515 may include a description of the uploaded logic (that may be helpful to other subscribers of the network), comments and the like. Other information may be details such as version information, dates (e.g., when the logic was created or generated etc.) and performance related data, e.g., type of threats detected by the logic, success rate etc.

As shown by block 520, the flow may include presenting information related to the logic to subscribers of the network. For example, server 110 may provide lists of uploaded logics or logic units to subscribers of network 130. A provided list of logics may include any comments or other information provided by the user that uploaded the logic, e.g., information uploaded as shown by block 515. Provided with information describing the logic, subscribers may use such information to determine whether they wish to download and use the logic.

As shown by block 525, the flow may include downloading the logic from the network, by a second subscriber device. Generally, logic uploaded to a network may be shared in a way similar to the sharing of content over social networks. For example, server 110 may provide a user with a list of logics or logic units and enable a user to download logics. As described herein, logics may be packaged in NLUs or PNMs that may be downloaded. Downloading a logic (e.g., risk detection logic) may be based on a selection of a rule from a list of rules. For example, information uploaded by a user as shown by block 515 may include an indication of one or more rules implemented by the logic. Accordingly, users may download logic based on an associated rule. As described herein, users may search for logic to download based on any criteria. Server 110 may present a list of risk detection logics for download based on a criteria received from a user. For example, a user may provide server 110 with text describing a rule and server 110 may use such text to search for and locate logics (e.g., on storage 111) and present to the user with a list of logics associated with the indicated rule, e.g., logics that implement the rule.

As shown by block 530, the flow may include providing the downloaded logic to a detection system to enable the detection system to detect a risk related to a transaction. For example, a PNM or NLU uploaded to server 110 by device 120A may be downloaded from server 110 by device 120B and provided to detection system 122 on device 120B. Detection system 122 may be configured to execute logic in a downloaded NLU, e.g., in order to detect fraudulent transactions related to money laundering.

As shown by block 535, the flow may include uploading to the network, by a plurality of subscribers devices, information related to execution of the logic. For example, subscribers who have downloaded and used a logic may rate the logic or comment on the logic. Server 110 may receive rating, comments or feedback related to a logic and may further present such received information. For example, when listing logics or logic units, user ratings and other feedback may be displayed. Accordingly, a community of subscribers may share information related to logic. Contributors of content (e.g., logic, comments and ratings) may benefit from the collective and collaborative contributions that may be collected, processed and presented to a community of contributors. By allowing contributors to comment on, and/or rate contributions, and providing a community with an aggregated result of the contributions, barriers imposed by geography, competition and/or technical aspects may be lifted, thus creating a de-facto risk management social network.

As shown by block 540, the flow may include providing information related to execution of the logic to subscribers of the network. For example, server 110 may enable users to view any feedback related to a logic over network 130, e.g., included in a web page that may only be served to subscribers of the network. Accordingly, information and experience related to detection logic may be shared by a community of subscribers in addition to a sharing of the actual logic, e.g., in the form of executable code included in NLUs and/or PNMs. Any other information related to a logic and its usage or distribution may be presented. For example, server 110 may monitor the number of downloads of a logic and display such number thus enabling a subscriber to see how popular a logic is. Other aspects, e.g., the time period during which the logic was most popular (e.g., as measured by downloads per unit time), the type of subscribers that downloaded the logic (e.g., banks, governments, private sector) may all be tracked or monitored by server 110. Server 110 may perform any processing based on collected information. For example, averages, peaks and the like may be computed and presented to subscribers of network 130.

As shown by block 545, the flow may include downloading the logic from the network, by a third subscriber device, based on the information related to execution of the logic. For example, logic uploaded by a first subscriber (e.g., as shown by block 510) may be downloaded by a second subscriber (e.g., as shown by block 525) that may further comment on the logic (e.g., as shown by block 540), e.g., rate the logic based on executing it. A third subscriber may, based on the rating of the logic, decide to download the logic and use it. In some embodiments, logic may be updated based on comments or ratings. For example, similar to the way various software applications (e.g., web browsers and/or operating systems) may be automatically updated, e.g., by a vendor or provider of the applications, logic may be automatically updated. For example, client module 121 may be configured to periodically check whether updated versions of a specific logic are available on server 110. Client module 121 may be configured to automatically update a logic on a subscriber device, e.g., if one or more conditions are met. For example, if an update version of a logic has been downloaded by more than a predefined number of subscribers or if an updated version of a logic has been rated above a predefined rate or level by at least a predefined number of subscribers, client module 121 may automatically download an update and install the update, e.g., replace a previous version of a logic by an updated version. Other operations or series of operations may be used.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A method of distributing detection logic, the method comprising:
uploading to a server connected to a network, wherein a plurality of subscriber devices are connected to the network, by a first subscriber device of the plurality of subscriber devices, the first subscriber device associated with a first fraud detection system, digital transaction risk detection logic to detect financial fraud, the detection logic usable in detecting a financial fraud by being executed by the first fraud detection system, the server allowing the detection logic to be shared among the plurality of subscriber devices;
downloading, by a second subscriber device of the plurality of subscriber devices, the second subscriber device associated with a second fraud detection system, the detection logic via the network; and
providing the detection logic to the second fraud detection system to enable the second fraud detection system to detect a financial fraud by executing the detection logic.

2. The method of claim 1, comprising presenting by the server information related to the detection logic to users of at least some of the plurality of subscriber devices.

3. The method of claim 1, wherein the detection logic enables an implementation of a policy.

4. The method of claim 1, wherein the detection logic enables a detection of a transaction related to money laundering.

5. The method of claim 1, wherein downloading the risk detection logic is according to a selection of a rule from a list of rules, the list provided by the server.

6. (canceled)

7. (canceled)

8. The method of claim 1, comprising automatically updating the detection logic to produce an updated detection logic.

9. The method of claim 1, wherein the financial fraud is selected from the group consisting of: financial transaction fraud, money laundering and financial account fraud.

10. A system for distributing detection logic, the system comprising:
a storage device;
a processor configured to:
receive, over a network, a digital transaction risk detection logic usable in detecting a financial fraud from a first subscriber device in a plurality of subscriber devices, the first subscriber device associated with a first fraud detection system, the detection logic usable in detecting a financial fraud by being executed by the first fraud detection system, the processor allowing the detection logic to be shared among the plurality of subscriber devices;
store the detection logic on the storage device;
allow the detection logic to be shared among the plurality of subscriber devices; and
send the detection logic to a second subscriber device in the plurality of subscriber devices, the second subscriber device associated with a second fraud detection system;
wherein the detection logic is provided to a second fraud detection system on the second subscriber device to enable the second fraud detection system to detect a financial fraud by executing the detection logic.

11. The system of claim 10, wherein the processor is configured to present information related to the detection logic to a user of the second subscriber device.

12. The system of claim 10, wherein the detection logic enables an implementation of a policy.

13. The system of claim 10, wherein the detection logic defines an action to be performed upon detecting a risk.

14. The system of claim 10, wherein the processor is configured to send the detection logic to the second subscriber device according to a selection of a rule received from the second subscriber device.

15. The system of claim 10, wherein the processor is configured to send, to the second subscriber device, a list of downloadable detection logics based on a criteria received from the second subscriber device.

16. (canceled)

17. (canceled)

18. The system of claim 10, wherein the financial fraud is selected from the group consisting of: financial transaction fraud, money-laundering and financial account fraud.

19. The method of claim 1, comprising presenting a list of detection logics for download based on a criteria received from a user.

20. The method of claim 8, wherein updating the risk detection logic on a first system is based on input received from a second system.

21. The method of claim 1, comprising uploading to the server by the first subscriber device a rating associated with the detection logic, the rating relating to one or more of false positives, accuracy in detecting fraud, or money saved or recovered, the server making available the rating to the plurality of subscriber devices.

22. The system of claim 10 wherein the processor is configured to receive, over the network, a rating associated with the detection logic, the rating relating to one or more of false positives, accuracy in detecting fraud, or money saved or recovered, from the first subscriber device, the processor making available the rating to the plurality of subscriber devices.
